(19) United States
(12) Patent Application Publication
(10) Pub. No.: US 2023/0190436 A1
(43) Pub. Date: Jun. 22, 2023

(54) METHODS OF APPLYING A PRODUCT TO POULTRY VIA CLOACAL DRINKING

(71) Applicants: Perdue AgriBusiness LLC, Salisbury, MD (US); The Board of Trustees of the University of Arkansas, Fayetteville, AR (US)

(72) Inventors: Mikayla Baxter, Gravette, AR (US); John Sylvester, Princess Anne, MD (US); Normand Roger St-Pierre, Tangier, VA (US); Brittany Danielle Mahaffey Graham, Fayetteville, AR (US)

(21) Appl. No.: 18/082,547

(22) Filed: Dec. 15, 2022

Related U.S. Application Data
(60) Provisional application No. 63/290,367, filed on Dec. 16, 2021.

(51) Int. Cl. A61D 7/00; A01K 45/00

(52) U.S. Cl. CPC A61D 7/00; A01K 45/00

(57) ABSTRACT

A method of applying at least one product to poultry (e.g., chicken) via the cloaca. The method includes (i) stimulating cloacal drinking behavior of the poultry by blowing air on the cloaca, and (ii) spraying the at least one product on and/or around the cloaca to allow for the at least one product to enter the lower gastrointestinal tract of the poultry through cloacal drinking. The at least one product includes, for example, probiotics, vaccines, nutrients, supplements, and combinations thereof. The poultry includes, for example, newly hatched baby chicks, poults, or ducklings.

### CROSS REFERENCE TO RELATED APPLICATIONS

This application claims priority to U.S. Provisional Patent Application No.

63/290,367, filed Dec. 16, 2021, the entire contents of which have been incorporated herein by reference.

### TECHNICAL FIELD

The present invention relates to methods of applying a product (e.g., vaccines, nutrients, and/or supplements) to the lower gastrointestinal tract of poultry, e.g., young chickens or newborn chicks, poults, and ducklings, via the cloaca in a hatchery.

### BACKGROUND

Hatcheries are where fertile eggs are incubated and hatched into young chickens or baby chicks. Currently, vaccinations, nutrients, and/or supplements can be applied at the hatchery either pre-hatching or post-hatching of the young poultry. For example, vaccines, nutrients, and/or supplements can be applied (i) through the egg (i.e., in ovo), (ii) via injection into the young poultry after hatching (i.e., post hatch), and/or (iii) by spraying directly onto the young poultry after hatching (i.e., post hatch).

There remains a need, however, for improved methods of applying a product (e.g., vaccines, nutrients, and/or supplements) to the lower gastrointestinal tract of poultry, including, e.g., young chickens or newborn chicks, poults, and ducklings.

### BRIEF SUMMARY OF THE INVENTION

According to one embodiment, the present invention provides a method of applying at least one product to poultry via the cloaca. The method includes (i) stimulating cloacal drinking behavior of the poultry by blowing air on the cloaca, and (ii) spraying the at least one product on and/or around the cloaca to allow for the at least one product to enter the lower gastrointestinal tract of the poultry species through cloacal drinking.

According to one embodiment, the at least one product is present in one of liquid or powder form.

According to an embodiment, the at least one product includes one or more of probiotics, vaccines, nutrients, supplements, and combinations thereof.

According to an embodiment, the step of stimulating cloacal drinking behavior of poultry by blowing air on the cloaca is conducted via a piece of equipment.

According to an embodiment, the step of spraying the at least one product on and/or around the cloaca is conducted via a piece of equipment.

According to an embodiment, the method is conducted in a hatchery.

According to an embodiment, the poultry is at least one of newly hatched baby chicks, poults, or ducklings.

According to an embodiment, the applying of the at least one product to poultry via the cloaca allows for lower gastrointestinal tract microbial colonization and immune stimulation and development.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 illustrates a flowchart of a method of applying at least one product to poultry (e.g., chicken) via the cloaca according to one embodiment of the invention.

FIG. 2 is a graph that demonstrates the effect of cloacal probiotic application on reducing pathogen counts (i.e., gram negative bacteria) in the gastrointestinal tract of broiler chicks.

FIG. 3 is a graph that demonstrates the effect of cloacal probiotic application on reducing pathogen counts (i.e., Salmonella) in the gastrointestinal tract of broiler chicks.

### DETAILED DESCRIPTION OF THE INVENTION

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

The present invention relates to methods of applying a product (e.g., vaccines, nutrients, and/or supplements) to the lower gastrointestinal tract of poultry via the cloaca. The cloaca is the posterior orifice on birds that serves as the only opening for the digestive, reproductive, and urinary tracts. Young poultry sample their environment through oral ingestion and via a phenomenon called “cloacal drinking.” Cloacal drinking is a natural reflex that occurs when poultry place their cloaca on surrounding objects or liquids and transfer various environmental stimuli into the lower gastrointestinal tract via reverse peristalsis. Cloacal drinking allows for the young poultry to initiate the development of the immune system while they are still protected with maternal antibodies. The lower gastrointestinal tract is also the site of the Bursa Fabricius, where B lymphocytes develop and differentiate. The type and amount of poultry species that perform this reflux and the volume of liquid the cloaca uptakes tend to fluctuate with age. Thus, applying products, such as, e.g., vaccines, nutrients, and/or supplements, to the lower gastrointestinal tract of the bird (or poultry) via the cloaca allows for lower gastrointestinal tract microbial colonization and immune stimulation and development.

According to one embodiment, the present invention provides a method of applying at least one product to poultry via the cloaca. The method includes (i) stimulating cloacal drinking behavior of poultry by blowing air on the cloaca, and (ii) spraying the at least one product on and/or around the cloaca to allow for the at least one product to enter the lower gastrointestinal tract of poultry through cloacal drinking.

According to one embodiment, the present invention stimulates the cloacal drinking reflex by blowing air on the cloaca. In one embodiment, the temperature of the air that is blown on the cloaca will be at least the core body temperature of the poultry (e.g., baby chicks), which is about 95° F. The air rate should also be high enough to stimulate the behavior.

According to one embodiment, the present invention will spray a product at least once on the cloaca. Based on other previous research, liquid cloacal application is detectable in the rectum and the Bursa Fabricius within 15 minutes of such application (see, e.g., Van der Sluis et al., 2009) and is detectable in the duodenum, ileum, and ceca within one hour (see, e.g., Porter et al., 1997).

According to an embodiment, the at least one product is present in one of liquid or powder form. A liquid or powdered product will help to ensure that the poultry (e.g., baby chicks) will not be chilled and drop their core body temperature.

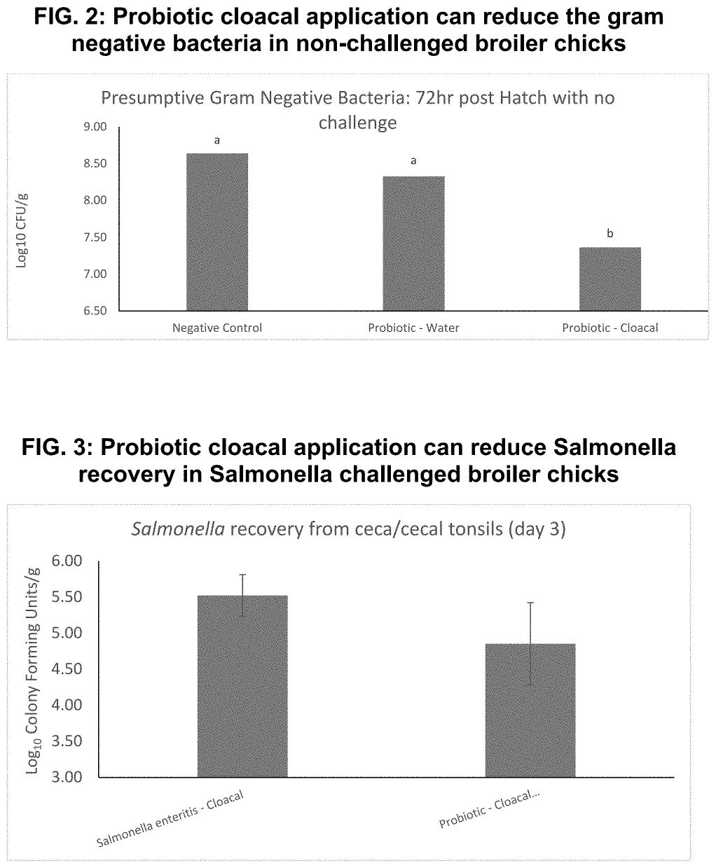

According to an embodiment, the at least one product includes one or more of probiotics, vaccines, nutrients, immune stimulants, supplements, and combinations thereof. Our current research has focused on the effect of early colonization of probiotics in the lower gastrointestinal tract of a poultry species (see, e.g., FIGS. 2 and 3, which demonstrate the effect of cloacal probiotic application on reducing pathogen counts in the gastrointestinal tract of broiler chicks), but this application method is not limited to one product. This application route also would benefit the application of vaccines, especially live vaccines. The effectiveness of oral live vaccines can be limited to the amount of attenuated live vaccine that can survive the acidic stomach or proventriculus. In addition, in birds, the location of the Bursa Fabricius (at the base of the rectum) suggests further vaccine and antigenic additives would allow cloacal application to stimulate an immune response. There have been some studies to suggest intra-cloacal application is an effective way to apply vaccines (see, e.g., Abaza et al., 2020) and may allow for young poultry to acquire immunological tolerance to environmental conditions (see, e.g., Hughes and Henderson, 1977; Ifrah et al., 2017).

According to an embodiment, the step of stimulating cloacal drinking behavior of the poultry (e.g., chicken) by blowing air on the cloaca is conducted via a piece of equipment.

According to an embodiment, the step of spraying the at least one product on and/or around the cloaca is conducted via a piece of equipment.

According to an embodiment, the method is conducted in a hatchery.

According to an embodiment, the poultry is at least one of newly hatched baby chicks, poults, or ducklings.

According to an embodiment, the applying of the at least one product to the poultry via the cloaca allows for lower gastrointestinal tract microbial colonization and immune stimulation and development.

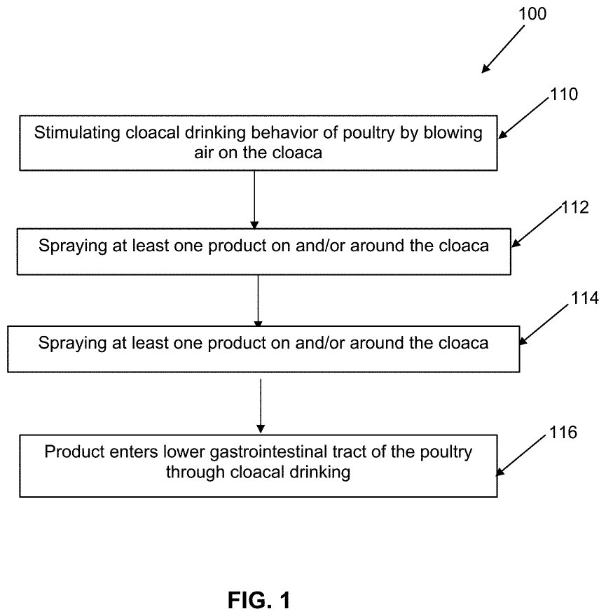

FIG. 1 illustrates a flowchart of a method (100) of applying at least one product to poultry (e.g., chicken) via the cloaca, according to one embodiment of the present invention. As shown in FIG. 1, the method (100) includes a first step (step 110) of stimulating cloacal drinking behavior of poultry by blowing air on the cloaca. The method (100) also includes a second step (step 112) of spraying at least one product on and/or around the cloaca. The method (100) can also include an additional step (step 114) of spraying at least one product, such as, e.g., the same or a different product, on and/or around the cloaca. Thereafter, at step 116, the product enters the lower gastrointestinal tract of the poultry through cloacal drinking.

In accordance with the principles of the present invention, a two-step process is provided that allows for applying various products (e.g., vaccines, nutrients, and/or supplements) to the lower gastrointestinal tract of poultry (e.g., chicken) via the cloaca in the hatchery through stimulation of natural behaviors (i.e., cloacal drinking). The types of products that could be applied via this application include, but are not limited to, probiotics, vaccines, nutrients, supplements, and combinations of those listed products. Application of these products through this delivery mechanism allows for lower gastrointestinal tract microbial colonization and immune stimulation and development.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

The following references are hereby incorporated by reference herein in their entireties:

Abaza, M., ElBorai, I., Eissa, A., & Zyan, K. (2020). Comparative Immunopathological Study of Various Intra-Cloacal Infectious Bursal Disease Vaccine Doses. Benha Veterinary Medical Journal, 39(2), 142-146.

Hughes, C. L., & Henderson, D. C. (1977). Induction of avian immunological responsiveness following cloacal drinking of immunogen. Immunological communications, 6(2), 195-206.

Ifrah, M. E., Perelman, B., Finger, A., & Uni, Z. (2017). The role of the bursa of Fabricius in the immune response to vaccinal antigens and the development of immune tolerance in chicks (Gallus domesticus) vaccinated at a very young age. Poultry science, 96(1), 51-57.

Porter Jr, R. E., Suckow, M. A., Macri, N. P., & Bowersock, T. L. (1997). Microsphere uptake by the intestine of white leghorn chickens. Avian diseases, 981-987.

Van der Sluis, H. J., Dwars, R. M., Vernooij, J. C. M., & Landman, W. J. M. (2009). Cloacal reflexes and uptake of fluorescein-labeled polystyrene beads in broiler chickens. Poultry science, 88(6), 1242-1249.

1. A method of applying at least one product to poultry via the cloaca, the method comprising:
(a) stimulating cloacal drinking behavior of the poultry by blowing air on the cloaca; and
(b) spraying the at least one product on and/or around the cloaca to allow for the at least one product to enter the lower gastrointestinal tract of the poultry through cloacal drinking.

2. The method according to claim 1, wherein the at least one product is present in one of liquid or powder form.

3. The method according to claim 1, wherein the at least one product includes one or more of probiotics, vaccines, nutrients, supplements, and combinations thereof.

4. The method according to claim 1, wherein the step of stimulating cloacal drinking behavior of the poultry by blowing air on the cloaca is conducted via a piece of equipment.

5. The method according to claim 1, wherein the step of spraying the at least one product on and/or around the cloaca is conducted via a piece of equipment.

6. The method according to claim 1, wherein the method is conducted in a hatchery.

7. The method according to claim 1, wherein the poultry is at least one of newly hatched baby chicks, poults, or ducklings.

8. The method according to claim 1, wherein the applying of the at least one product to the poultry via the cloaca allows for lower gastrointestinal tract microbial colonization and immune stimulation and development.
